(19) United States
(12) Patent Application Publication
(10) Pub. No.: US 2008/0020167 A1
(43) Pub. Date: Jan. 24, 2008

(54) Glass Sandwich Plate

(76) Inventors: Andreas Fuchs, Stuttgart (DE); Stefan Behling, London (GB); Wolf Herold, Diessen (DE); Thomas Nagele, Kaufering (DE)

Correspondence Address: MH2 TECHNOLOGY LAW GROUP, LLP, 1951 KIDWELL DRIVE, SUITE 550, TYSONS CORNER, VA, 22182, US

(21) Appl. No.: 11/568,594

(22) PCT Filed: Apr. 5, 2005
(86) PCT No.: PCT/EP05/03580

§ 371 Date: Apr. 20, 2007

(30) Foreign Application Priority Data
May 4, 2004 (EP) 04010587.6

(51) Int. Cl. B32B 17/10; B32B 17/06; E06B 3/66

(52) U.S. Cl. 428/53

(57) ABSTRACT

A glass sandwich plate comprises a spacer arrangement (12) disposed between two glass panes (10, 11) and formed as a continuous unit from a 0.2 mm thick aluminum sheet by punching and deforming such that webs (18) are formed which extend at different angles with respect to the glass panes. The webs (18) extend between plane connecting areas (17) at which the spacer arrangement (12) is glued to the glass panes (10, 11) by means of a radiation curable acrylate or epoxide adhesive. With this structure, the sandwich plate has a high breaking strength at low weight and is suitably used for sight and sun protection.

### PRIOR ART

Glass is generally a brittle material having a very high compressive strength of about 800 N/mm². Due to micro fissures in the glass surface, however, the tensile strength is only about 80 N/mm². The well-known tendency of glass to break is due to the fact that these micro fissures tear under bending stress. Therefore, to achieve a higher breaking strength, tensile stress on the glass surface must be kept low. To this end, pre-stressed glass (ESG (single-layer safety glass)), for example, is heated and rapidly cooled during manufacture. This creates a tensile stress in the core and a compression stress at the surfaces.

ESG is a safety glass in which the pane, due to pre-stressing, breaks to small, dull-edged and hardly injuring pieces. In case of windows, however, a substantial risk of injury is caused by falling sheets of coherent scraps. For this reason, insulating roof windows employ ESG only on the outer side. There are also safety composite panes in which two panes are glued to an intermediate plastic sheet to which the glass pieces adhere in case of breakage.

Since glass roof elements must withstand high snow loads and strong winds, static considerations often require a minimum thickness of 5 mm for ESG glass (exterior) and of 2×6 mm for layered glass (VSG (laminated safety glass)) panes (interior). Such a pane element has a substantial weight which must be supported by expensive and massive support and frame structures and does not permit large spans. The high weight of the glass elements limits the maximum span due to the maximum permissible bending.

For large-size two-pane load-bearing laminated glass panes, structural measures have to be taken to keep the bending stress low. At the same time, no large glass pieces should break from the pane upon fracture, in order to meet the requirements of a safety glass.

EP 0 630 322 B1 discloses a glazing element in which rib fibers form a space between two panes. This spacer fabric is glued to the pane surfaces over the full area. If the spacer fabric is to effect any significant increase in the bending strength of the composite glass, it must be woven relatively densely. This, in turn, impairs the transparency of the glass throughout its area. Moreover, the fabric and the glue surfaces will discolor by ultraviolet radiation in the course of its use in daylight. In spite of being non-transparent, this element is not useful for sun protection. Besides, the fiber layer is hardly effective to prevent burglary.

It is recommended to evacuate the space between the panes to obtain a composite glass pane of good thermal insulation. As set forth in the paper by F. B. Grimm “Glas als tragender Baustoff” in “Glas plus Rahmen” (1991) 19, 1020-1028, the high forces of 10 t/m² require spacers between the panes. Such spacers are neither optically appealing nor inexpensive to incorporate in the manufacturing process of a composite glass pane.

DE 29 50 348 A1 discloses a safety composite pane of two transparent panes with an intermediate wire skeleton.

A sandwich plate having the features included in the preamble of claim 1 is known from the paper by J. Wurm et al “Glas-EFK Sandwichplatten im Fassaden-bau”, “Glas” (2004) 2, 44-48. The spacer arrangement of this sandwich plate consists of webs glued between two glass panes, wherein the webs all extend in the same direction under such an oblique angle to the surface of the panes that direct sunlight is shaded whereas diffuse daylight is permitted to pass largely unaffected.

### SUMMARY OF THE INVENTION

It is a general object of the invention to avoid at least some of the disadvantages which occur with comparable prior-art sandwich plates. A more specific object may be seen in the provision of a sandwich plate which can withstand high load at small weight and which may also be used as a safety pane, which provides selective protection against direct sun radiation but is opaque at defined angles and thus appears semitransparent, which has low heat conduction values if used as an insulating pane, and which may be employed as an aesthetic element in construction works.

This object is met by the invention defined in claim 1. The spacer arrangement of claim 1, which is formed of sheet metal, has a small weight of its own. It can transmit only tensile and compressive forces but no bending moments. Thus, substantially only tensile and compressive forces are generated in the panes, which are preferably made of glass, but hardly any bending moments which otherwise would very rapidly cause the panes to break.

The embodiment of the invention set forth in claim 2 has the advantage that the spacer arrangement is stable even if the edges between the panes are not reinforced. The overall wave-like or zigzag shape of the arrangement acts has the effect of a lattice work. The high structural and flexural strength of the spacer arrangement permits light-weight and filigree structures which do not require additional support even with large dimensions.

In the embodiment of claim 3, the spacer arrangement is particularly easy to manufacture and to incorporate between the panes. The embodiment of claim 4 is useful to avoid stress peaks in the regions where the metal webs are connected to the panes.

The feature of claim 5 serves to achieve the desired transparency. Depending on the size and shape of the perforations, an overall light transmitting sandwich plate is obtained which is semitransparent under certain angles. A large number of modifications may be made by varying the form and the perforations. The perforations and the three-dimensional form result in a free visibility through the perforations under certain angles. Sun beams and light may enter directly into the interior under these angles, while incident rays will be blocked at other angles. It is thus possible to protect a room against direct midday sun while permitting the pleasant morning or afternoon light to pass freely.

When used inside buildings, the partial transparency of the sandwich plate can provide interesting effects which can be well exploited by architects. For example, walls or doors may be made which prevent direct visibility of the room behind while permitting the room to be viewed from a lateral direction.

The feature of claim 6 provides a suitable protection in terms of heat and visibility.

The feature of claim 7 is advantageous because of the resulting small weight.

The adhesive employed in accordance with claim 8 is specifically suitable as it may be cured through the transparent panes even in the assembled condition of the sandwich plate. The adhesive connection between the panes and the spacer arrangement makes the sandwich plate a hybrid structural part which is capable of transmitting high forces in spite of its small weight. The adhesive is UV stable and highly transparent. It has no effect on the partial transparency of the overall sandwich plate because it is applied in those areas between the metal webs and the panes which are not transparent anyway. UV stability is essential as the adhesive, if discoloured, would appear unpleasant through the transparent panes.

Suitable dimensions are given in claims 9 to 12. Stress peaks may be largely prevented from building up under forces exerted on the pane by selecting the thickness and elasticity of the adhesive layer at the contact locations between the pane and the spacer arrangement.

Thermal and even acoustic insulation may be achieved in the embodiment of the invention set forth in claim 13.

According to claim 14, the invention may be applied also to curved sandwich plates.

The sandwich plate herein described can withstand high load with very small bending. It was found, for instance, that a glass sandwich element consisting of two cover panes of 2 to 3 mm each and a thin aluminum sheet of 0.2 mm and having an overall thickness of 10 mm was capable of withstanding four times the bending stress taken by a 4 mm thick monolithic glass pane, or is substantially lighter at the same permissible load, which is desirable in every respect when used for construction purposes.

Due to its own low weight and high strength, a horizontal glazing may have an essentially larger span with significantly smaller material expenditure of the support structure.

The present glass sandwich plate also meets the requirements of safety glass. With an overhead glazing, for instance, there is no risk of persons being injured by large falling glass pieces because the panes are solidly connected by the adhesive to the contact faces of the shaped filler element throughout their surfaces at a small spacing of 3 to 10 mm. The panes are held along the breaking line of the glass by the stable and deformable spacer arrangement which is made of sheet metal, so that only small harmless glass pieces may leave the composite. In the broken condition, the glass sandwich plate retains a residual strength when supported linearly along four sides, which corresponds to a VSG pane of 2×TVG (partially pre-stressed glass).

The space between the panes may be evacuated to achieve a suitably low thermal transmittance below k=1 W/m²K. This requires only a diffusion-tight sealing at the edges. The spacer arrangement withstands high vacuum forces so that no concave deformation of the glass panes will occur. The contact areas between the spacer arrangement and the panes are so small that only very small point-like thermal bridges are created, wherein the connecting adhesive additionally acts as a thermal insulator. The vacuum also increases the acoustic insulation.

The secure connection between the panes through the inner spacer arrangement prevents geometric deformations of the pane edges under load so that the sealing of the edge connection does not deteriorate. Therefore, no highly resilient sealing materials are required to withstand mechanical or thermal deforming forces; instead, a simple, thin aluminum sheet and a diffusion-tight adhesive are sufficient. Any additional support framing of the sandwich plate is unnecessary since the rigidly and adhesively interconnected structural parts provide a static strength which by far exceeds that of externally applied supporting frames.

If low heat radiation values are desired, emission lowering layers (low-E layers) may be applied to the inner surface of the outer pane.

### BRIEF DESCRIPTION OF THE DRAWINGS

Embodiments of the sandwich plate according to the invention will now be described in more detail with reference to the drawings in which:

FIGS. 1 and 3 are explosive representations of two different arrangements, and

FIG. 2 is a plane view of the spacer arrangement used in the sandwich plate of FIG. 1.

### EMBODIMENTS

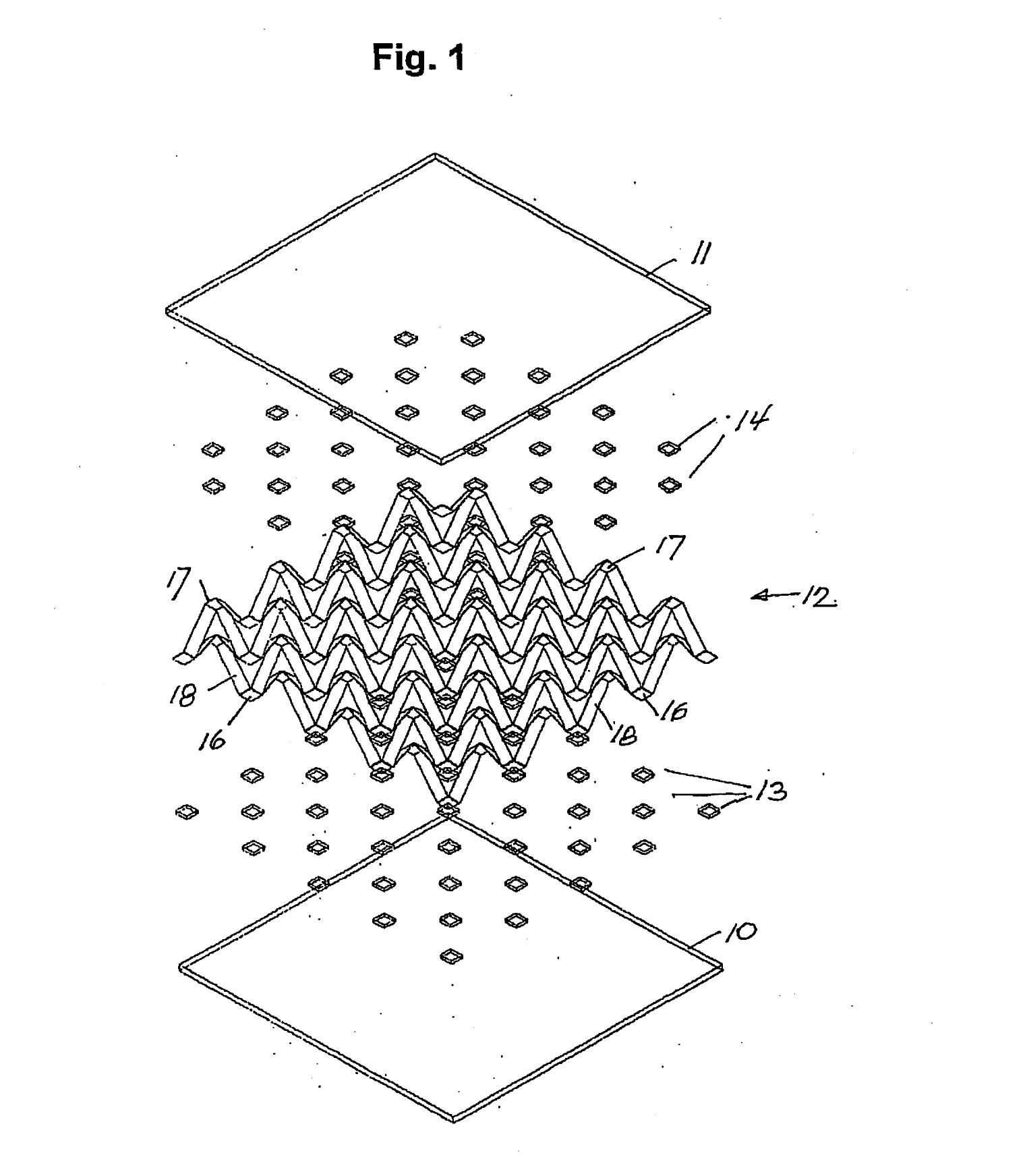

The sandwich plate shown in FIG. 1 consists of a lower glass plate 10 having a thickness of 2 mm, an upper glass pane 11 having also a thickness of 2 mm, and an intermediate spacer arrangement 12 which is connected to the panes 10, 11 by means of adhesive spots 13, 14 shown separately in the drawing. The spacer arrangement 12 is formed by punching and deforming a 0.2 mm thick aluminum sheet. In the finished condition, the panes 10, 11 are mutually spaced by, e.g., 10 mm.

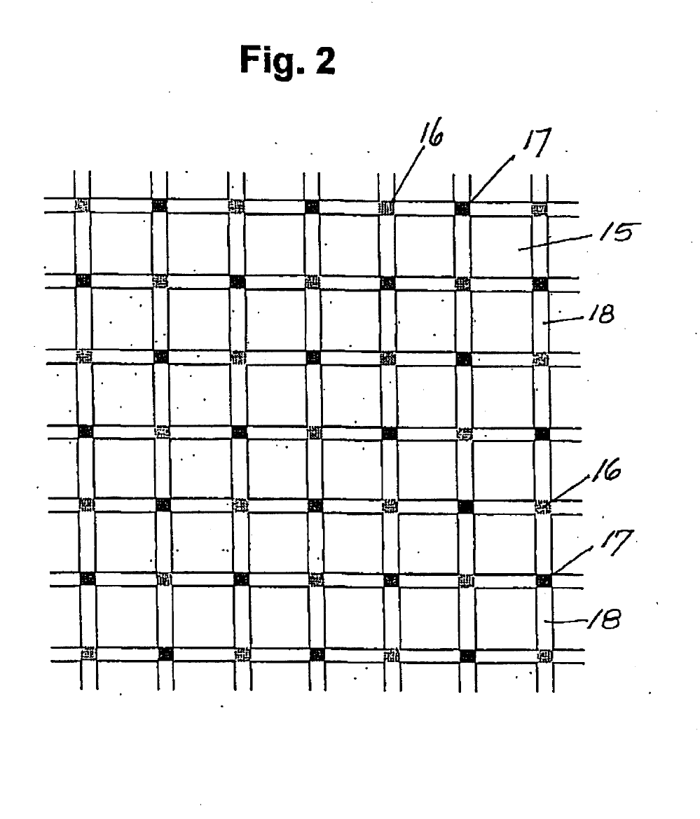

FIG. 2 is a plane view of the starting metal sheet of the spacer arrangement 12 with grid-like punched square perforations 15. The adhesive spots 13, 14 are applied to the crossing points 16, 17 between the webs 18 of the grid. In the deforming process, the crossing points 16, 17 are pressed, in both co-ordinate directions alternately, upward and downward, so that the crossing points 16, 17 are alternately offset in two parallel planes. The webs 18 extend at angles of 45° to 60° with respect to these planes. In FIG. 2, the crossing points 16 which have been pressed downward, are shown light, whereas the crossing points 17 which have been pressed upward are shown dark.

The transitions between the webs 18 and the crossing points 16, 17 are rounded rather than bent sharply in order to avoid peak stress at the locations where they are glued to the glass panes 10, 11. The rounding is not shown in the schematic drawing of FIG. 1.

In assembly, highly precise amounts of adhesive are applied, e.g., jetted without contact, onto the lower glass pane 10 at locations precisely corresponding to the crossing points 16 to form the lower adhesive spots 13. Alternatively, the adhesive may be jetted onto the crossing points 16 of the deformed spacer arrangement 12. Subsequently, the spacer arrangement 12 is placed on the pane 10 by means of a precise parallel placing process, and the adhesive is cured. In a second step, adhesive is applied to the upper crossing points 17 to form the adhesive spots 14, and the second glass pane 11 is placed parallel thereon.

Using a UV or light curing adhesive achieves short manufacturing times. As soon as the spacer arrangement 12 has been placed on the lower pane 10, a light source is turned on which has an emission spectrum selected in accordance with the photo initiator of the adhesive. Since the pane is transparent, the adhesive cures within few seconds. The process is repeated for fixing the upper glass pane 11.

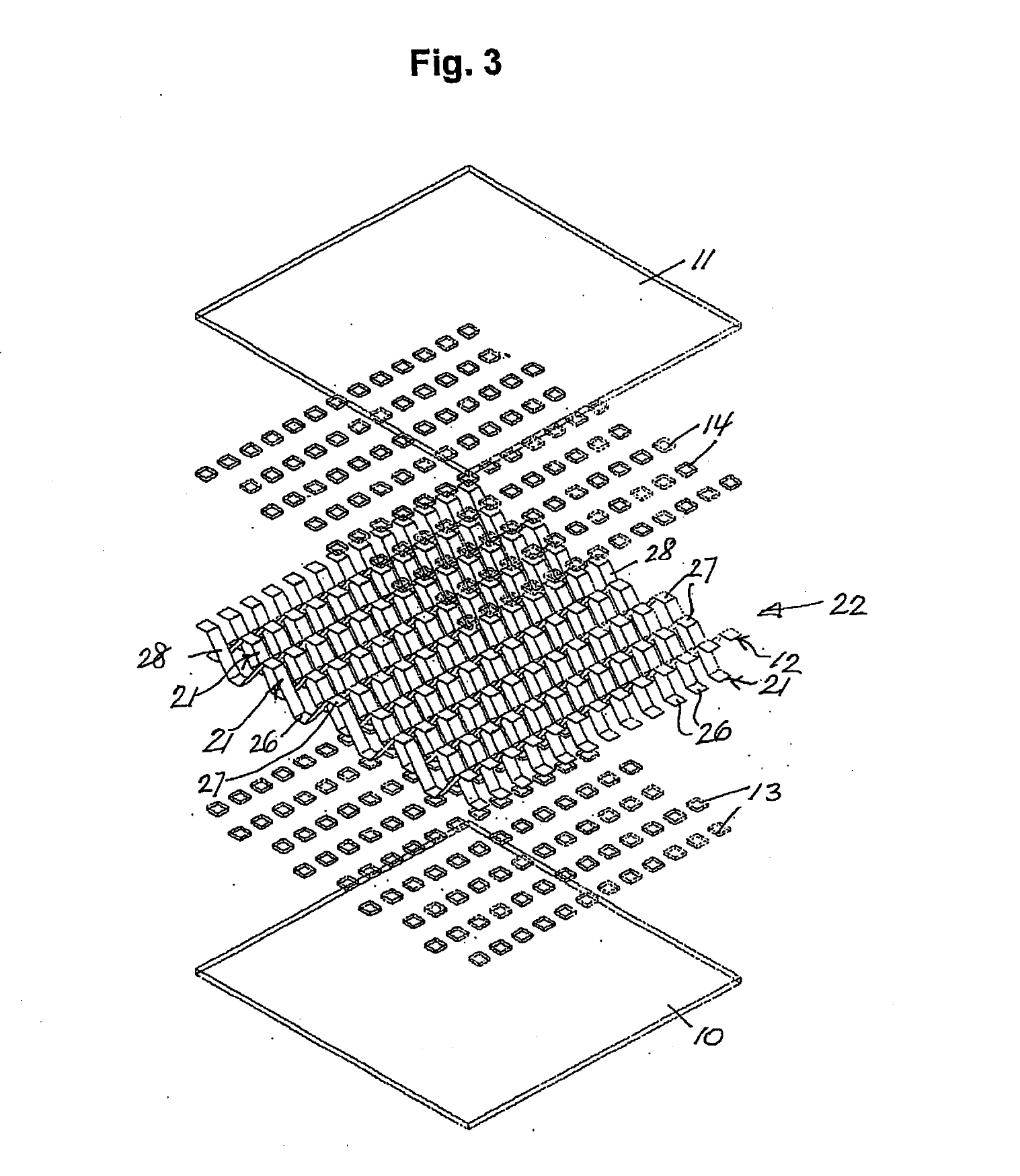

The sandwich plate shown in FIG. 3 differs from that of FIG. 1 in the shape of the spacer arrangement 22 which is made from a metal sheet provided with cuts rather than perforations. In this case, the cuts delimit web strips 21 extending in only one coordinate direction, each strip being bent alternately upward and downward so as to again form connecting areas 26, 27 which are offset alternately in parallel planes and interconnected by webs 28 which extend at angles of 45° to 60° with respect to these planes. Adjacent web strips 21 are deformed in opposite directions so that the lower connecting areas 26 of one web strip are aligned with the upper connecting areas 27 of the adjacent web strips. Each cut has such a length that adjacent web strips 21 are contiguous only in the middle of the respective webs 28. This is not shown in the schematic representation of FIG. 3.

The drawings show sandwich plates made of parallel plane panes 10, 11. The invention is likewise applicable to curved panes.

1-14. (canceled)

15. A sandwich plate comprising a pair of transparent panes and a spacer and disposed between said panes and fixed thereto by an adhesive, said spacer being formed of sheet metal and including webs extending obliquely to the surfaces of said panes.

16. The sandwich plate of claim 15, wherein said spacer includes webs extending at different angles with respect to the planes of said panes.

17. The sandwich plate of claim 15, wherein said webs are formed from said sheet metal as a continuous unit by punching and deforming.

18. The sandwich plate of claim 17, wherein said webs are rounded in areas in which they contact the panes.

19. The sandwich plate of claim 17, wherein adjacent webs of said spacer are separated from one another by perforations formed in said sheet metal.

20. The sandwich plate of claim 15, wherein said sheet metal has a reflective surface.

21. The sandwich plate of claim 15, wherein said sheet metal is made of aluminum.

22. The sandwich plate of claim 15, wherein said adhesive is a radiation curable acrylate or epoxide adhesive.

23. The sandwich plate of claim 22, wherein said adhesive is applied in a thickness of less than 0.5 mm.

24. The sandwich plate of claim 15, wherein said sheet metal has a thickness of 0.1 to 0.3 mm.

25. The sandwich plate of claim 15, wherein either pane has a thickness of 1.5 to 4 mm.

26. The sandwich plate of claim 15, wherein said sheet metal has a thickness of 0.2 mm and either pane has a thickness of 3 mm.

27. The sandwich plate of claim 15, wherein said panes are spaced apart by 3 to 20 mm.

28. The sandwich plate of claim 15, wherein the space between said panes is evacuated.

29. The sandwich plate of claim 15, wherein said panes are curved.
